(19) United States
(12) Patent Application Publication
(10) Pub. No.: US 2004/0216828 A1
(43) Pub. Date: Nov. 4, 2004

(54) Nonwoven fabrics with two or more filament cross sections

(76) Inventors: Albert E. Ortega, Pensacola, FL (US); R. Wayne Thomley, Pensacola, FL (US); Jan Mackey, Gulf Breeze, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 32606-6669, US

(21) Appl. No.: 10/863,960

(22) Filed: Jun. 8, 2004

Related U.S. Application Data
(62) Division of application No. 10/223,910, filed on Aug. 19, 2002.
(60) Provisional application No. 60/313,200, filed on Aug. 17, 2001.
(60) Provisional application No. 60/331,812, filed on Nov. 20, 2001.

(51) Int. Cl. D04H 1/56; D04H 3/16; B32B 5/02; B32B 5/08

(52) U.S. Cl. 156/62.4; 156/62.6; 156/167; 156/308.6; 156/244.26

(57) ABSTRACT

The subject invention concerns nonwoven fabrics containing filaments of at least two different cross sections. The subject invention further pertains to methods used to produce these fabrics. In an embodiment specifically exemplified herein, the nonwoven fabric of the subject invention is made of nylon.

### CROSS-REFERENCE TO RELATED APPLICATION

This application is a divisional application of copending application U.S. Ser. No. 10/223,910, filed Aug. 19, 2002; which claims the benefit of provisional patent applications Serial No. 60/313,200, filed Aug. 17, 2001 and Serial No. 60/331,812, filed Nov. 20, 2001, which are hereby incorporated by reference in their entirety.

### FIELD OF INVENTION

This invention relates to new nonwoven fabrics made with two or more filament cross sections. The mixed filament cross sections give these new fabrics advantageous properties.

### BACKGROUND OF INVENTION

Nonwoven fabrics and numerous uses thereof are well known to those skilled in the textiles art. Such fabrics can be prepared by forming a web of continuous filaments and/or staple fibers and bonding the fibers at points of fiber-to-fiber contact to provide a fabric of requisite strength. The term “bonded nonwoven fabric” is used herein to denote nonwoven fabrics wherein a major portion of the fiber-to-fiber bonding referred to is adhesive bonding accomplished via incorporation of adhesives in the web to “glue” fibers together or autogenous bonding such as obtained by heating the web or by the use of liquid or gaseous bonding agents (usually in conjunction with heating) to render the fibers cohesive or mechanical bonding, particularly autogenous bonding, the web may be subjected to mechanical compression to facilitate obtaining adequate bonding.

Properties of nonwoven fabrics are determined by several factors, including but not limited to, the method used to produce the fabrics, the polymer or polymer combinations used, the bonding method, the bond pattern, the fabrics, the structure of the fabric, the filament cross section, the filament denier (dpf) and the basis weight of the fabric. Nonwoven fabrics made with filaments with all round, all trilobal or all hollow cross sections are commonly found. These filament cross sections impart specific properties to the fabrics such as opacity or coverage, thickness, loft, strength, hand or softness, luster, fiber surface area to facilitate coating, tensile strength, water absorption and other properties.

Spunbonded nonwoven fabrics formed of nylon, polyester, polypropylene, or other man-made polymers are widely used commercially for a number of purposes. Such fabrics exhibit excellent strength, coverage, hand and permeability properties and accordingly are desirable for use in construction fabrics, filtration material, mattress pads, mattress pad skirts, medical fabrics and furniture and bedding backing materials. The fabric can be produced via the well-known spunbonding process in which molten polymer is extruded through one or more spinnerets into filaments. Bicomponent or multicomponent spinning methods as described in U.S. Pat. Nos. 3,968,307; 4,052,146; 4,406,850; 4,424,257; 4,424,258; 4,830,904; 5,534,339; 5,783,503; 5,895,710; 6,074,590; and 6,207,276, incorporated by reference, can also be used to make multiconstituent filaments of different cross sections. The filaments are attenuated and drawn pneumatically and deposited onto a collection surface to form a web. The web is then bonded together to produce a strong, coherent fabric. Filament bonding is typically accomplished either thermally or chemically, i.e., autogenously. Thermal bonding is accomplished by compression of the web of filaments between the nip of a pair of cooperating heating calender rolls thereby setting the thickness. In autogenous bonding of nylon filaments, the web of filaments is transported to a chemical bonding station or “gashouse” which exposes the filaments to an activating agent (i.e., HC1) and water vapor. Water vapor enhances the penetration of the HC1 into the filaments and causes them to become tacky and thus amenable to bonding. Upon leaving the bonding station, the web passes between rolls which compress and bond the web thereby setting the thickness. Adequate bonding is necessary to minimize fabric fuzzing (i.e., the presence of unbonded filaments) and to impart good strength properties to the fabric. Autogenous bonding has been especially used in forming spunbonded nylon industrial fabrics. Mechanical compression normally sets the loft or thickness of fabrics with similar basis weights. It is common practice to increase thickness and strength by increasing the basis weight, or the mass per square area.

In many applications, the lightest nonwoven fabric that meets the product property requirements is used due to cost factors. A nonwoven fabric that would meet the requirements by yielding the desired properties at lighter basis weights would reduce costs. A process that makes such fabrics would also be beneficial.

Thickness or loft and coverage or opacity of nonwoven fabrics is normally determined by the basis weight. Increasing the basis weight adds cost due to the use of more raw materials. It is desirable to have increased thickness or coverage in some applications where these fabrics are used without increasing the basis weight. Thickness, coverage and strength can sometimes be affected by the filament cross section. Lighter weight fabrics with higher strength, loft or coverage would be more desirable and less costly.

Nonwoven fabrics are also used in a variety of coating applications. Coating materials will be captured and held more effectively onto a fabric that contains more fiber surface area. Fabrics that use less coating to effect the same desired results would be more cost effective and desirable.

Fabrics made with trilobal filaments tend to exhibit specular reflection. Although trilobal filaments have been effective in increasing coverage or opacity in fabrics, there is a need to reduce the specular reflection or “glittering” of these fabrics. A fabric with the coverage of a trilobal fabric with no glittering effect would also be advantageous.

### BRIEF SUMMARY

The subject invention concerns nonwoven fabrics containing filaments of at least two different cross sections. The subject invention further pertains to methods used to produce these fabrics. In an embodiment specifically exemplified herein, the nonwoven fabric of the subject invention is made of nylon. The non-woven fabric can be made by, for example, altering the filament cross section in a portion of the capillaries in the same spinneret or by using spinnerets with different filament cross sections on opposing sides of a spunbond beam.

The subject invention also provides advantageous processes for providing lighter fabrics that have the same properties as fabrics having higher basis weights. In a preferred embodiment, an improved nonwoven nylon fabric is produced by using filaments with at least two different cross sectional shapes. An important advantage of the process of the subject invention is that it provides a fabric with enhanced coverage and thickness, while maintaining excellent strength and softness characteristics of the nonwoven fabric.

In another embodiment, the nonwoven fabric can be produced by mechanically blending staple yarn with filaments of different cross sections into a web. This web is then formed into a bonded nonwoven fabric using adhesives or mechanical methods such as, but not limited to, carding, needle punching, air laying, wet laying, hydroentangling, powder or adhesive bonding, air bonding, thermal bonding and chemical bonding.

In specific embodiments, the fabrics of the subject invention have filaments with two or more cross sections that are round, crescent, multilobal, oval, diamond or a cross section with voids (hollow filaments). The multilobal filaments have at least two lobes and, preferably, three or more lobes. In a preferred embodiment, the multilobal filaments are trilobal.

The use of multilobal filaments is particularly advantageous for maximizing coatings since these filaments have more surface area. The fabrics may have a dpf ranging from about 0.5 dpf to about 20 dpf.

### DETAILED DISCLOSURE

In the following detailed description of the subject invention and its preferred embodiments, specific terms are used in describing the invention; however, these are used in a descriptive sense only and not for the purpose of limitation. It will be apparent to the skilled artisan having the benefit of the instant disclosure that the invention is susceptible to numerous variations and modifications within its spirit and scope.

The present invention concerns nonwoven fabrics with filaments of two or more different cross sections that provide properties better than fabrics with filaments of a single cross section. As used herein, reference to two or more cross sections refers to the shape of the cross sections. The subject invention further concerns methods used to produce these fabrics.

The fabrics of the subject invention have, for example, increased coverage or opacity compared to conventional nonwoven fabrics and have higher thickness while maintaining softness and strength at the same basis weight and dpf. In a preferred embodiment, round filaments are mixed with trilobal filaments to produce nonwoven fabrics. These fabrics have more opacity, stronger tensile properties and hold more coating material than fabrics made with only round cross section filaments because the trilobal filaments add strength by the way they pack in the fabric and add opacity by the way they reflect light. They also hold more coating material since trilobal filaments have more surface area.

The nonwoven fabrics of the subject invention have basis weights from 0.1 ounce per square yard up to 7 ounces per square yard. In a preferred embodiment, the weight of the fabric produced as described herein is between about 0.5 and about 2.5 ounces per square yard. In a specific embodiment, the fabric is about 1.15 ounces per square yard. The characteristics of the fabrics of the subject invention are achieved utilizing filaments having, for example, round, crescent, diamond, oval, hollow, and/or multilobal cross-sections.

In a preferred embodiment, the predominant fiber cross section is selected from the group consisting of round, multi-lobal, cresent, hollow, diamond and oval. As used herein, reference to the “predominant” cross section means that, by number, that cross section makes up a greater percentage of the filaments than any other single cross section. In a preferred embodiment, the predominant cross section comprises at least about 10% by number of the filaments. More preferably the filaments with the predominant cross section comprise at least 15%. The filament with the predominant cross section may comprise up to 95% of the filaments by number. Thus, the filaments with the predominant cross section may comprise from about 10% to about 95% of the filaments by number. The percentage can be any percentage between 10 and 95 and every such percentage between 10 and 95 is specifically contemplated by the subject matter.

The remaining filaments, in addition to the predominant filament, are preferably selected from the group consisting of round, multilobal, crescent, hollow, diamond and oval. As used herein, reference to hollow filaments contemplates one or more voids within the filaments.

The subject invention further concerns methods to produce these fabrics that contain filaments with at least two different cross sections. Any man-made (synthetic) polymer can be used, such as, but not limited to, polycaprolactum, polyamide, polyester, polyethylene, polypropylene, polylactic acid, nylon 10, nylon 11 and nylon 12. Blends and mixtures of man-made polymers can also be used. Conjugate spinning or multicomponenet spinning methods, known to those skilled in the art, can be employed to make filaments of at least two different polymer types with two or more different cross sections.

The fabrics can be produced by, for example, installing spinnerets with capillaries of different cross sections on different positions, sides or beams of a spunbond machine. Spinnerets with different capillary cross sections or capillary sizes within the same spinneret can also be used. The fabrics can also be produced by blending fiber with filaments of different cross sections using carding methods and then using dispersing methods to produce a nonwoven web such as, but not limited to, air laying or wet laying methods, needle punching or hydoentangling. This web is then formed into a nonwoven fabric using adhesives or mechanical methods such as, but not limited to, powder or adhesive bonding, air bonding, thermal bonding or chemical bonding. Discrete bonds between the filaments may account for 5% to 50% of the area of the fabric and, more preferably, 16% to 24% of the area.

The fabrics of the subject invention can also be produced by extruding a plurality of continuous filaments, directing the filaments through an attenuation device, such as slots or jets, to draw the filaments, depositing the filaments onto a collection surface such that a web is formed, and bonding the filaments together either autogenously or thermally to form a coherent, strong fabric. In a specific embodiment, the fibers (filaments) of the fabric of the subject invention need not be crimpled. In a further specific embodiment the fibers are not melt blown. In a further specific embodiment, the filaments are continuous.

As would be appreciated by those skilled in the art, reference herein to the molecular orientation of a filament pertains to the alignment or arrangement of polymer chains in the filament. Molecular orientation is increased when filaments are drawn. In contrast to spunbond filaments, melt blown filaments are not drawn and therefore have little to no orientation of their polymer chains.

In a specific embodiment of the subject invention, fabrics with two or more filament cross sections can be made using a nylon spunbond method utilizing a slot drawing mechanism or attenuation jets. Typically, the nylon compound will be nylon 6, 6 and/or nylon 6; however, other man-made fibers from polymers such as, but not limited to, polyester, polypropylene, polyethylene or other polyamides or combinations of such can be used. Also, mixtures, blends or copolymers can be used as taught in U.S. Pat. Nos. 5,431,986 and 5,913,993 both of which are incorporated herein by reference.

In one embodiment, polyethylene, polypropylene, and/or polyester can be added to the nylon material. This produces a softer feel and increases water repellency. In the case of polyethylene, the polyethylene should have a melt index between about 5 grams/10 min and about 200 grams/10 min and a density between about 0.85 grams/cc and about 1.1 grams/cc. The polyethylene can be added at a concentration of about 0.05% to about 20%.

Nylon filaments produced during the process of the subject invention may be bonded chemically, ultrasonically, or thermally. In one embodiment, HCl gas and water vapor can be applied to achieve boding as described in U.S. Pat. No. 3,853,659 incorporated herein by reference. In another embodiment, the filaments may be heated to, for example, between 180° C. and about 250° C. Preferably, the filaments are heated to between about 200° C. and 235° C.

It should be understood that the examples and embodiments described herein are for illustrative purposes only and that various modifications or changes in light thereof will be suggested to persons skilled in the art and are to be included within the spirit and purview of this application and the scope of the appended claims.

### EXAMPLE 1

Nonwoven fabric samples with two or more filament cross sections can be made using nylon 6,6 polymer by installing a spinneret with round capillaries on one side and a spinneret with trilobal capillaries on the other side of a dual spinning beam. Other combinations of cross sections can be used as shown in Table 1 below. The number of spinneret holes can be adjusted to produce fabrics with filaments that are less than 1.5 times larger than the smallest filaments in the fabric. Spinnerets with the same number of holes and the same spinneret throughput will yield the same dpf for all filaments. The nylon 6,6 polymer can be melted and extruded at a temperature of about 295° C. Filaments can then be attenuated and drawn pneumatically using aspirating jets or a slot device and deposited onto a laydown or forming box. The resulting webs can then be directed to a calender where about 20% of the surface area is bonded at discrete points at a temperature of about 216° C. It is expected that fabrics with some trilobal filaments will have higher opacity at the same basis weight than fabrics containing only round filaments.

TABLE 1
Possible Combinations of cross sections for Example 1

| | Cross Section on Other Side |
|---|---|
| Cross Section on One Side of Beam | of Beam |
| Round | Crescent |
| Round | Hollow |
| Round | Diamond |
| Round | Oval |
| Round | Multilobal |
| Trilobal | Hollow |
| Trilobal | Diamond |
| Trilobal | Oval |
| Trilobal | Multilobal |
| Hollow | Diamond |
| Hollow | Oval |
| Hollow | Multilobal |
| Dimaond | Oval |
| Diamond | Multilobal |
| Crescent | Trilobal |
| Crescent | Hollow |
| Crescent | Diamond |
| Crescent | Oval |
| Crescent | Multilobal |
| Oval | Multilobal |

For comparison, commercially available fabrics under the trade name of “PBN-II”, Type 30 and Type 31 by CEREX Advanced Fabrics, Inc. are made with round filaments in the entire web and trilobal filaments in the entire web, respectively.

### EXAMPLE 2

Nonwoven fabric samples can be made using nylon 6,6 polymer by installing a spinneret or spinnerets where more than 50% but less that 95% of the capillaries are of a round cross section and the remaining are of a trilobal cross section. Placing the different cross sections in the same spinneret will yield the same dpf for all filaments.

The nylon 6,6 polymer can be melted and extruded at a temperature of about 295° C. Filaments can then be attenuated and drawn pneumatically using aspirating jets or a slot device and deposited onto a laydown or forming box. The resulting webs can then be directed to a calender where about 20% of the surface area is bonded at discrete points at a temperature of about 216° C.

Combinations of two different cross sections as shown in Table 1 can also be used to produce sample fabrics. Combinations of three or more filament cross sections can be created by adding one or more different cross sections in any possible combination to the items in Table 1 above. Filaments from each different cross section must comprise at least five or more percent of the total number of filaments. Filaments from any of the cross sections can make up the largest percentage of the total filaments in the web. For example, a fabric can be comprised of 40% hollow filaments, 25% round filaments, 25% trilobal filaments, 5% diamond filaments and 5% oval filaments.

### EXAMPLE 3

Nonwoven fabric samples can be made using nylon 6,6 or nylon 6 polymer or a combination of both as in example 1, except, the resulting web can be autogeneously bonded by directing the web to a chemical bonding station where the web filaments are bonded using HC1 gas and water vapor at a temperature around 39° C. The fabrics are produced by chemically bonding the filaments together in a gas house. The web is then subjected to a roll treatment in which the web is compacted and further bonded.

### EXAMPLE 4

Nonwoven fabric samples can be made using nylon 6,6 or nylon 6 polymer or a combination of both as in Example 2, except, the resulting web can be autogeneously bonded by directing the web to a chemical bonding station where the web filaments are bonded using HC1 gas and water vapor at a temperature around 39° C. The fabrics are produced by chemically bonding the filaments together in a gas house. The web is then subjected to a roll treatment in which the web is compacted and further bonded.

### EXAMPLE 5

Nonwoven fabric samples can be made using polyester, polypropylene or polyethylene by installing spinnerets on respective sides of a spin beam as described in Example 1. The specific polymer must be melted and extruded at the appropriate temperature to achieve satisfactory spinning performance. Filaments can then be attenuated and drawn pneumatically using aspirating jets or a slot device and deposited onto a laydown or forming box. The resulting web can then be directed to a calender where about 20% of the surface area is bonded at discrete points at the appropriate temperature required to bond the web based on the polymer.

### EXAMPLE 6

Nonwoven fabric samples can be made as described in Examples 1 through 5 above using mixtures, blends or copolymers of man made polymers.

### EXAMPLE 7

Nonwoven fabric samples can be made as described in Examples 1 through 6 above using conjugate spinning or bicomponent spinning methods.

### EXAMPLE 8

A web of filaments can be produced with a blend of filaments with different cross sections in combinations listed in Table 1. Filaments with different cross sections can comprise at least one and, preferably, at least five or more percent of the total number of filaments. The web can then be formed into a bonded nonwoven fabric using adhesives or mechanical methods using the processes commonly referred to as carding, needle punching, wet laying, air laying, hydroentagling, powder or adhesive bonding, through air bonding, thermal bonding or chemical bonding.

### EXAMPLE 9

Fabrics can be produced as described in Examples 1 through 8 above with mixed filaments of different cross sections. Certain cross sections can cause spectral reflection which is not desirable in some applications. Small amounts of titanium dioxide can be added if spectral reflection is objectionable.

### EXAMPLE 10

Nonwoven fabric samples can be made using nylon 6,6 polymer by installing a spinneret or spinnerets where at least 14.5% of the capillaries are of a round cross section, 5% are of a trilobal cross section and the remaining capillaries are a combination of oval, multilobal, hollow, crescent or diamond cross sections. Placing the different cross sections in the same spinneret will yield the same dpf for all filaments. The nylon 6,6 polymer can be melted and extruded at a temperature of about 295° C. Filaments can then be attenuated and drawn pneumatically using aspirating jets or a slot device and deposited onto a lay down or forming box. The resulting webs can then be directed to a calender where about 20% of the surface area is bonded at discrete points at a temperature of about 216° C. Other percentages of different cross sections can be used to produce sample fabrics. Filaments from any of the cross sections can make up the largest percentage of the total filaments in the web. For example, a fabric can be comprised of 40% hollow filaments, 25% multilobal, 10% round filaments, 10% trilobal filaments, 2% diamond filaments, 8% crescent, and 5% oval filaments.

It should be understood that the examples and embodiments described herein are for illustrative purposes only and that various modifications or changes in light thereof will be suggested to persons skilled in the art and are to be included within the spirit and purview of this application.

We claim:

1. A method of producing a nonwoven fabric comprising filaments with molecular orientation and wherein the filaments have two or more different cross sections; wherein said method comprises using spinnerets that have different cross sections to form filaments and directing a plurality of said filaments onto a collection surface to form a web.

2. The method, according to claim 21, wherein discrete bond sites are formed in the fabric by heating the web of filaments in discrete areas and forming thermal bonds.

3. The method, according to claim 2, wherein the discrete thermal bonds comprise 5% to 50% of the fabric area.

4. The method, according to claim 3, wherein the discrete thermal bonds comprise 16% to 24% of the fabric area.

5. The method, according to claim 1, wherein a multiplicity of discrete bond sites is formed in the fabric by forming bonds autogenously at the filament cross over points.

6. The method, according to claim 5, wherein the filaments are nylon and the step of forming bonds autogenously at the filament cross over points comprises contacting the filaments with gas which will render the filaments cohesive and form bonds at their cross over points.

7. The method, according to claim 1, wherein the same spinneret forms filaments with two or more different cross sections.

8. The method, according to claim 1, wherein different spinnerets are used to form filaments with two or more different cross sections.
